(19) United States
(12) Patent Application Publication
(10) Pub. No.: US 2005/0095886 A1
(43) Pub. Date: May 5, 2005

(54) Card connector having an eject mechanism easy to operate and assuring reliable movement

(76) Inventor: Keisuke Nakamura, Tokyo (JP)

Correspondence Address: WILLIAM COLLARD;COLLARD & ROE, P.C., 1077 NORTHERN BOULEVARD, ROSLYN, NY, 11576, US

(21) Appl. No.: 10/953,617

(22) Filed: Sep. 16, 2004

(30) Foreign Application Priority Data
Sep. 17, 2003 (JP) 324091/2003

(51) Int. Cl. H01R 13/62

(52) U.S. Cl. 439/157

(57) ABSTRACT

A lever is rotatably attached to a connector body to be connected to a card. The lever has a first card-pressing portion formed at a position where a rotation radius is relatively small, and a second card-pressing portion formed at a position where the rotation radius is relatively large. Following the rotation of the lever, the first card-pressing portion pushes and moves the card. Thereafter, the second card-pressing portion pushes and moves the card. Consequently, the card is removed from the connector body.

This application claims priority to prior Japanese patent application JP 2003-324091, the disclosure of which is incorporated herein by reference.

### BACKGROUND OF THE INVENTION

This invention relates to a card connector having an eject mechanism for removing a card from the card connector.

A card connector of the type is disclosed, for example, in Japanese Patent Application Publications (JP-A) Nos. H10-189139 and 2002-231381 and comprises a slider applied with an operating force and a rotatable lever engaged with the slider. The lever has a pressing portion for pressing a card during rotation. When an operator slides the slider, the lever is rotated around a supporting point so that the pressing portion of the lever pushes and moves the card. As a consequence, the card is ejected from the card connector.

In case where the lever is designed so that a distance between the supporting point and the pressing portion is short, a stroke of the card upon ejection is shortened and a sufficient eject amount may not be obtained. On the other hand, in case where the lever is designed so that the distance between the supporting point and the pressing portion is long, a large operation force is required to obtain a sufficient ejecting force. In this event, operability is impaired. Generally, the lever is designed so that the pressing portion presses an approximate center of one edge of the card. Therefore, a sufficient eject amount and a sufficient operability can not be obtained.

### SUMMARY OF THE INVENTION

It is therefore an object of the present invention to provide a card connector having an eject mechanism assuring a sufficient eject amount and excellent operability.

Other objects of the present invention will become clear as the description proceeds.

According to an aspect of the present invention, there is provided a card connector comprising a connector body to be connected to a card and a lever rotatably attached to said connector body, said lever having a first card-pressing portion formed at a position where a rotation radius is relatively small and a second card-pressing portion formed at a position where the rotation radius is relatively large, said first card-pressing portion being adapted to push and move said card following the rotation of said lever, said second card-pressing portion being adapted to push and move said card after said card is pushed and moved by said first card-pressing portion, thereby removing said card from said connector body.

### BRIEF DESCRIPTION OF THE DRAWING

FIG. 1A is a perspective view of a card connector according to a first embodiment of the present invention;

FIG. 1B is an exploded perspective view of the card connector illustrated in FIG. 1A;

FIG. 1C is a perspective view of a part of a modification of the card connector;

FIG. 2 is a perspective view of the card connector in FIG. 1A when a card is connected to the card connector;

FIG. 3 is a perspective view of a lever used in the card connector in FIG. 1A;

FIG. 4 is a plan view showing an internal mechanism of a characteristic part of the card connector in FIG. 1A when the card is connected thereto;

FIG. 5 is a view similar to FIG. 4 when the card is being ejected from the card connector in FIG. 1A;

FIG. 6 is a view similar to FIG. 4 after the card has been ejected from the card connector in FIG. 1A;

FIG. 7 is a perspective view of a lever used in a card connector according to a second embodiment of the present invention;

FIG. 8 is a plan view showing an internal mechanism of a characteristic part of the card connector in FIG. 7 when a card is connected thereto;

FIG. 9 is a view similar to FIG. 4 when the card is being ejected from the card connector in FIG. 7; and

FIG. 10 is a view similar to FIG. 4 after the card has been ejected from the card connector in FIG. 7.

### DESCRIPTION OF THE PREFERRED EMBODIMENTS

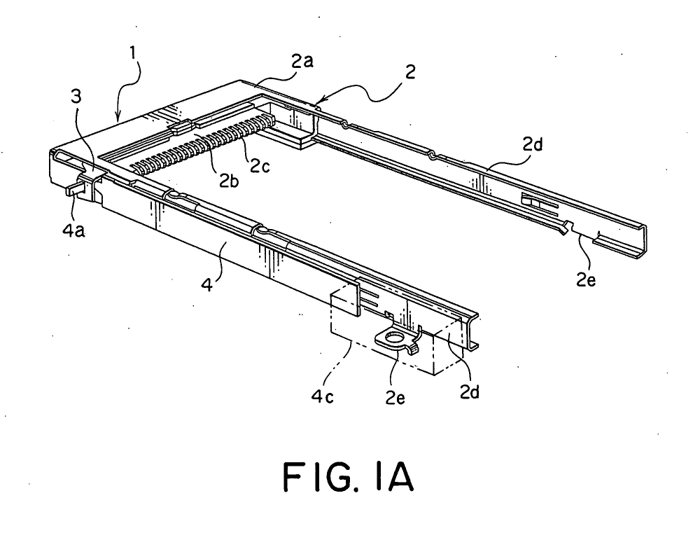

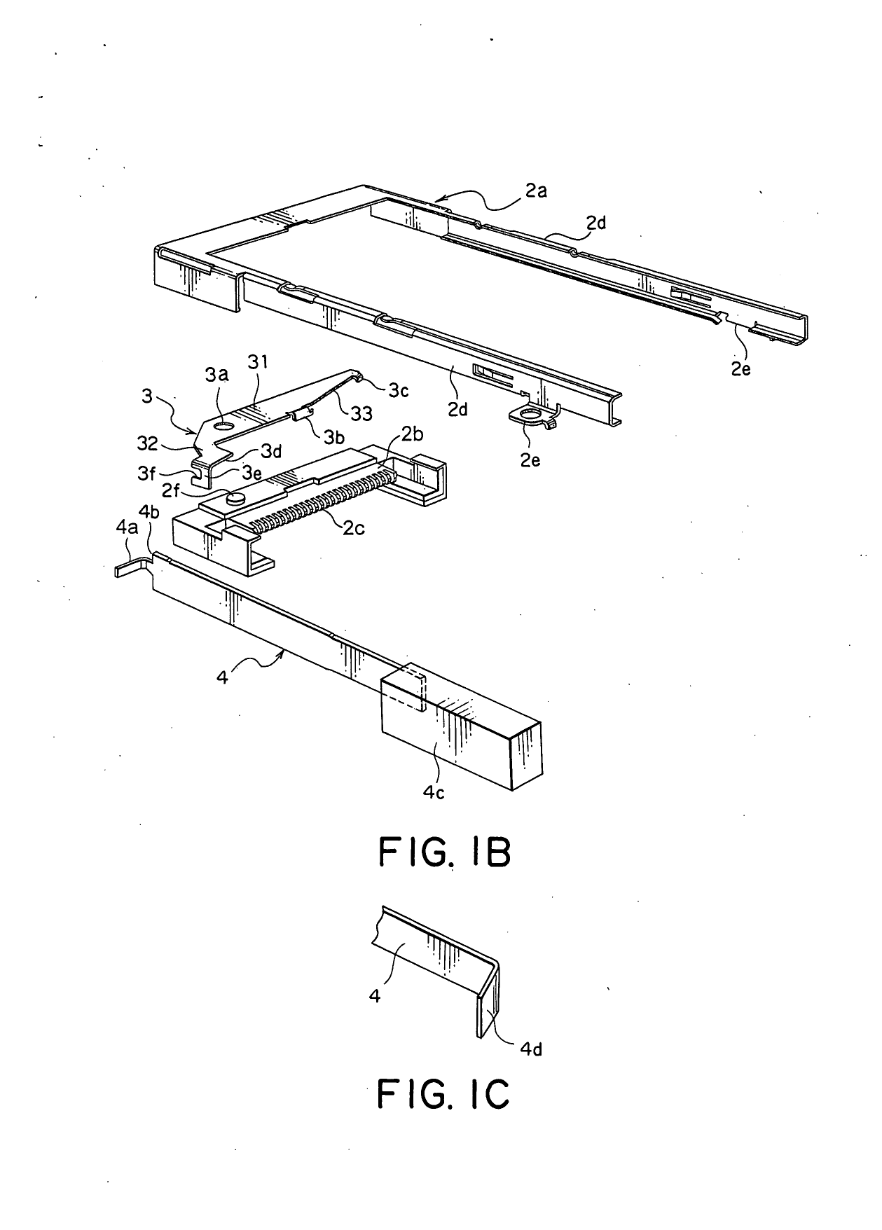

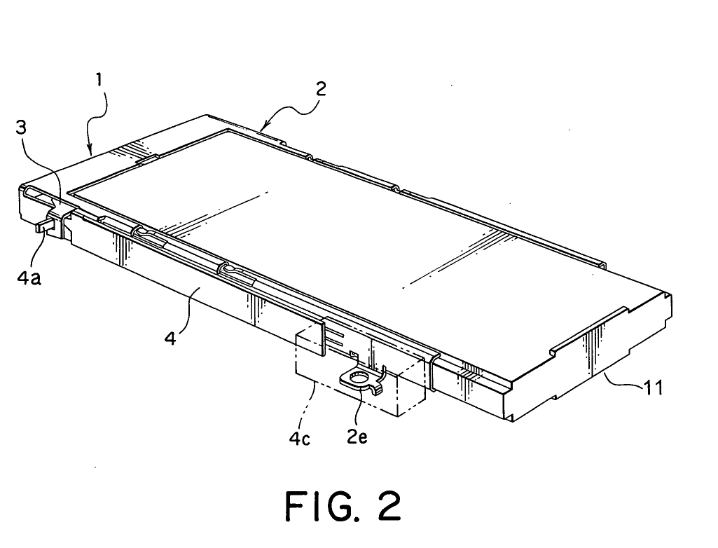

Referring to FIGS. 1A, 1B, and 2, a card connector 1 according to a first embodiment of the present invention will be described. The card connector 1 comprises an eject mechanism as will later become clear and may be used in a notebook-type personal computer, a mobile telephone, a personal digital assistant, or the like.

The card connector 1 illustrated in the figures comprises a generally U-shaped connector body 2. As illustrated in FIG. 2, a card 11 is inserted into the card connector 1. The card 11 inserted into the card connector 1 is fitted to the connector body 2 and electrically connected thereto.

The connector body 2 has a U-shaped frame 2a, an insulator 2b fitted to a bottom portion of the U-shaped frame 2a, and a number of conductive contacts 2 held by the insulator 2b and arranged at a predetermined pitch. The frame 2a has a pair of guide members 2d having a channel-like shape and faced to each other with a space left therebetween. The guide members 2d cooperate with each other to form a card guide for guiding the movement of the card 11. The frame 2a is provided with a pair of fixing portion 2e formed on opposite sides thereof to fix the card connector 1 to a printed board or the like.

The card connector 1 further comprises a lever 3 rotatably attached to a pivot portion 2f formed on the insulator 2b, and a metal slider 4 having a long plate-like shape and disposed outside one of the guide members 2d to be slidable in a predetermined direction, i.e., a longitudinal direction. The slider 4 has a first end provided with a bent part 4a and an engaging end 4b, and a second end provided with a plastic operating button 4c.

Alternatively, the frame 2a may be provided with a pivot portion to which the lever 3 is rotatably attached. As illustrated in FIG. 1C, the slider 4 may have another bent portion 4d instead of the plastic operating button 4c.

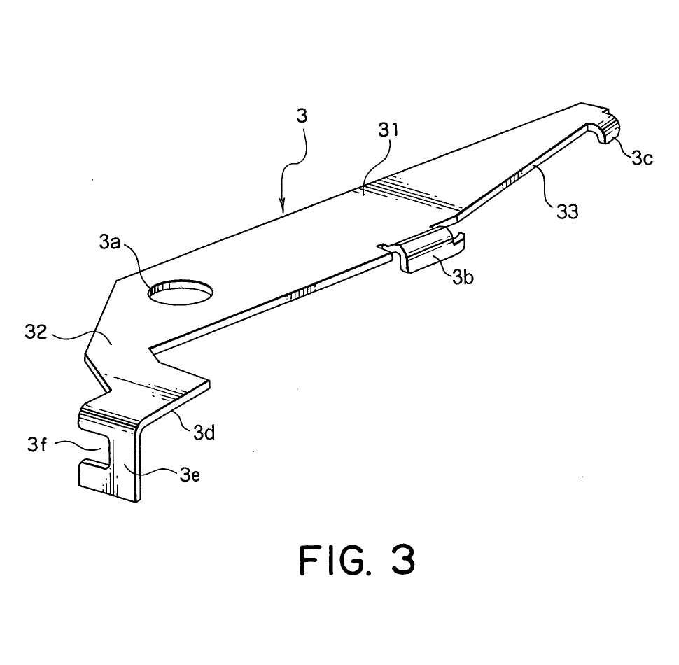

Referring to FIG. 3 together with FIG. 1B, description will be made of a structure of the lever 3 and a relationship between the lever 3 and the slider 4.

The lever 3 is provided with a circular hole 3a formed at a position slightly spaced from the center of the lever 3 and fitted to the pivot portion 2f so that the lever 3 is rotatable. The lever 3 has an acting portion 31 located at one side (right side in the figures) of the circular hole 3a, and an operating portion 32 located at the other side (left side in the figures) of the circular hole 3a. The acting portion 31 has a first card-pressing portion 3b formed on its one side surface at or around its center, i.e., at a position where a rotation radius is relatively small. Further, the acting portion 31 has a second card-pressing portion 3c formed on the one side surface in the vicinity of a rotating end, i.e., at a position where the rotation radius is relatively large. Each of the first and the second card-pressing portions 3b and 3c is formed by bending. The acting portion 31 has a depressed portion 33 formed between the first and the second card-pressing portions 3b and 3c. The operating portion 32 has a portion 3d engaged with the engaging end 4b of the slider 4, and a bent portion 3e perpendicularly bent from the pressed portion 3d. The bent portion 3e is provided with a cutaway portion 3f engaged with the bent part 4a at the first end of the slider 4.

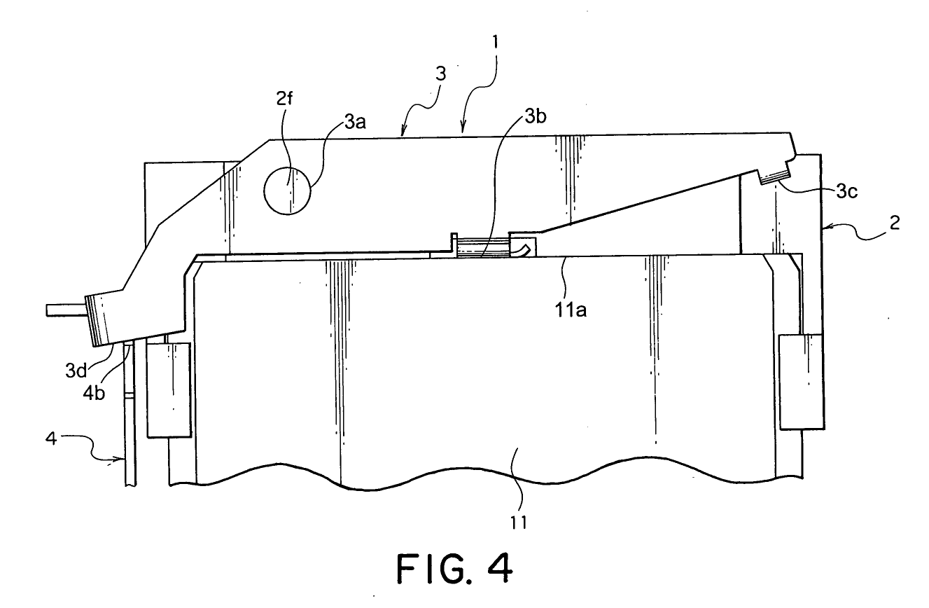

Referring to FIGS. 4 to 6 in addition, an ejecting operation will be described.

In FIG. 4, the card 11 is connected to the connector body 2 in a normal state. In this state, the first card-pressing portion 3b is contacted with or closely adjacent to an approximate center of a front edge 11a of the card 11. On the other hand, the second card-pressing portion 3c is apart from the card 11.

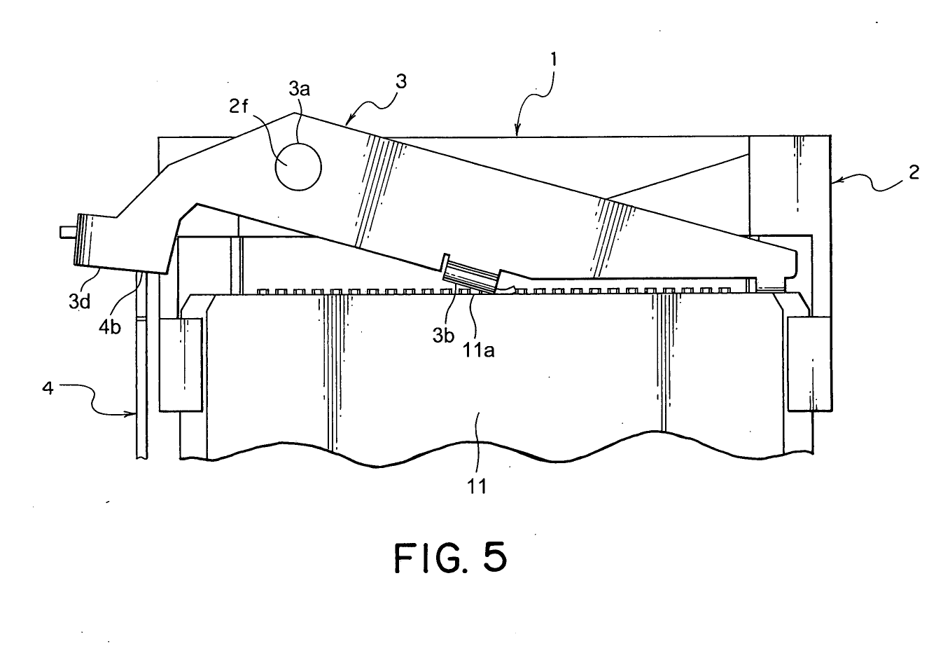

When the operating button 4c of the slider 4 is pushed, the engaging end 4b of the slider 4 presses the pressed portion 3d of the lever 3. In this event, the lever 3 is rotated around the pivot portion 2f in a clockwise direction. As a result of the rotation of the lever 3, the first card-pressing portion 3b of the lever 3 presses the front edge 11a of the card 11. Consequently, the card 11 is pushed and moved by the first card-pressing portion 3b to be removed from the connector body 2 as illustrated in FIG. 5. Thus, electrical connection between the connector body 2 and the card 11 is disconnected.

The first card-pressing portion 3b is formed on the acting portion 31 at the position where the rotation radius is relatively small. Therefore, only a small operating force is required to remove the card 11 from the connector body 2. In other words, even with a small operating force, a sufficiently large ejecting force is obtained. In the state illustrated in FIG. 5, the second card-pressing portion 3c is contacted with or closely adjacent to one end of the front edge 11a of the card 11.

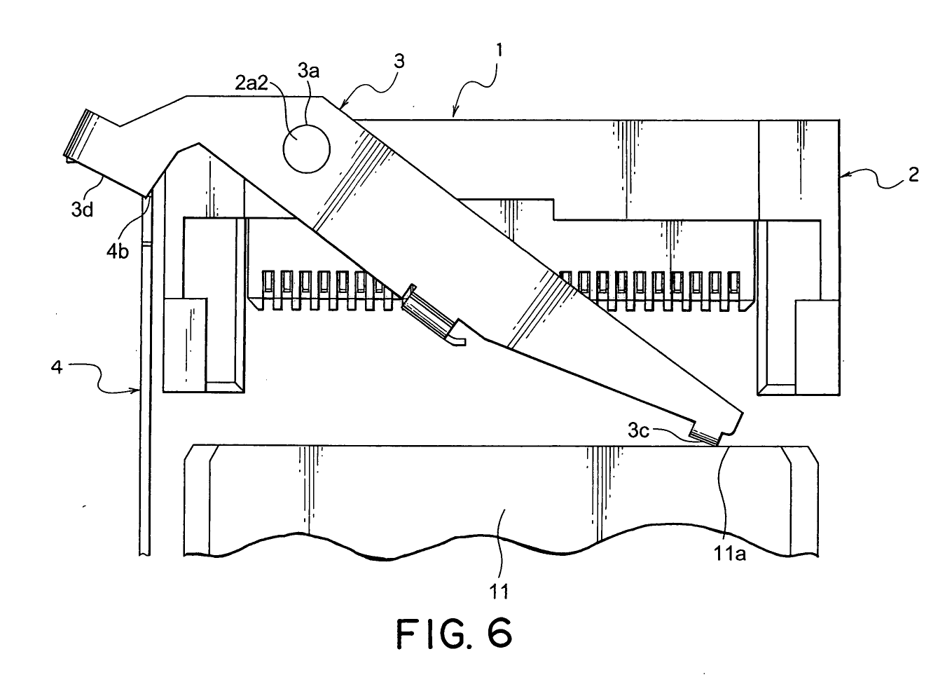

When the slider 4 is further pushed, the lever 3 is further rotated around the pivot portion 2f in the clockwise direction. Then, the second card-pressing portion 3c of the lever 3 presses the front edge 11a of the card 11. As a consequence, the first card-pressing portion 3b of the lever 3 is separated from the card 11. Thereafter, the card 11 is pushed and moved by the second card-pressing portion 3c to be ejected from the card connector 1 as illustrated in FIG. 6.

Since the second card-pressing portion 3c is formed on the acting portion 31 at the position where the rotation radius is relatively large, a sufficiently large stroke can be obtained. It is therefore possible to more reliably eject the card 11 from the card connector 1.

In the illustrated example, the lever 3 is provided with the first and the second card-pressing portions 3b and 3c. Between the first and the second card-pressing portions 3b and 3c, at least one similar card-pressing portion may be formed as an additional card-pressing portion.

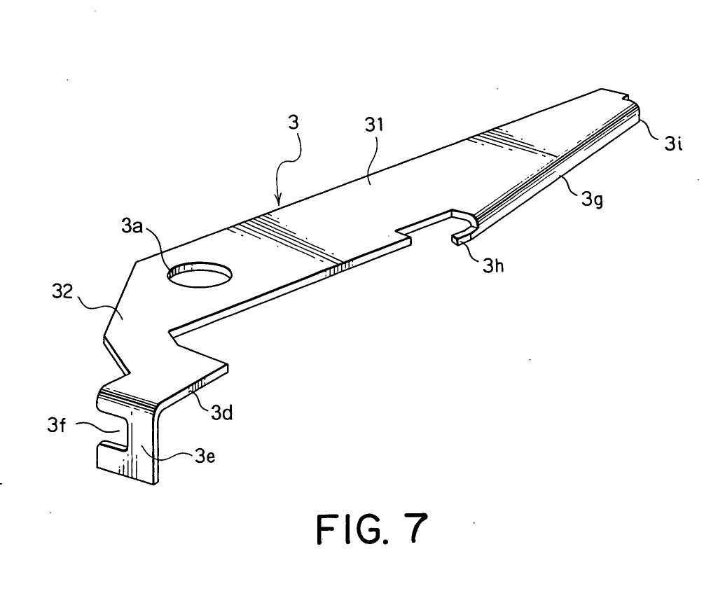

Further referring to FIGS. 7 through 10, description will be made of a card connector 1a according to a second embodiment of the presen invention. The card connector 1a is similar to the card connector 1 illustrated in FIGS. 1A and 1B. Similar parts are designated by like reference numerals and description thereof will be omitted.

The card connector la illustrated in the figure has a card continuously-pressing portion 3g formed at one position of the lever 3, as illustrated in FIG. 7. The card continuously-pressing portion 3g is formed by bending on one side surface of the acting portion 31 to linearly extend continuously from one end or the rotating end to a position around the center of the acting portion 31. The card continuously-pressing portion 3g may be understood as a combination of first and second card-pressing portions 3h and 3i formed at one end and the other end thereof, respectively, and smoothly and continuously connected by the above-mentioned additional card-pressing portion.

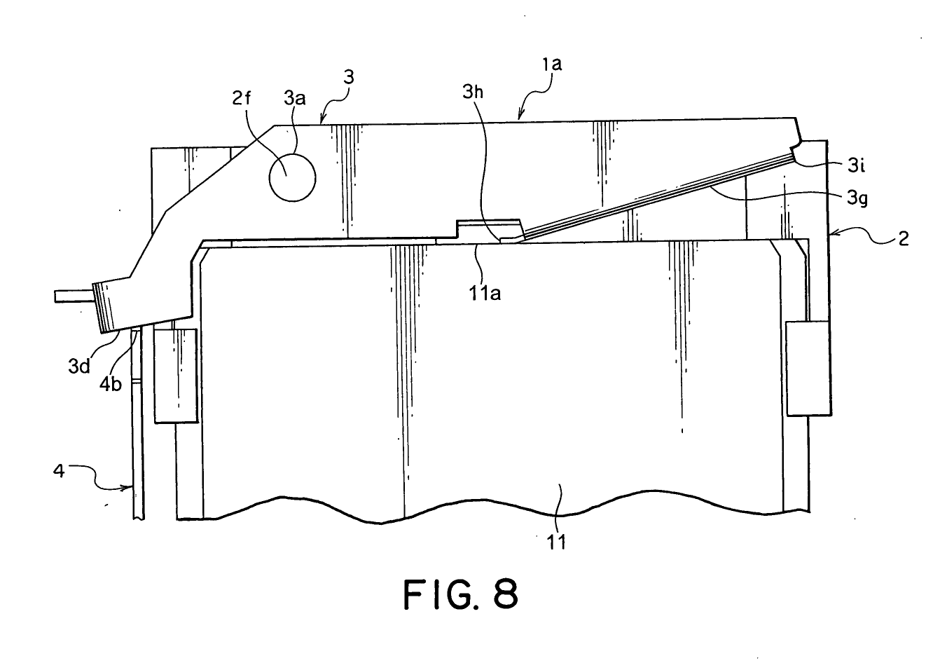

In FIG. 8, the card 11 is connected to the connector body 2 in a normal state. In this state, the first card-pressing portion 3h is contacted with or closely adjacent to the approximate center of the front edge 11a of the card 11. On the other hand, the second card-pressing portion 3i is apart from the card 11.

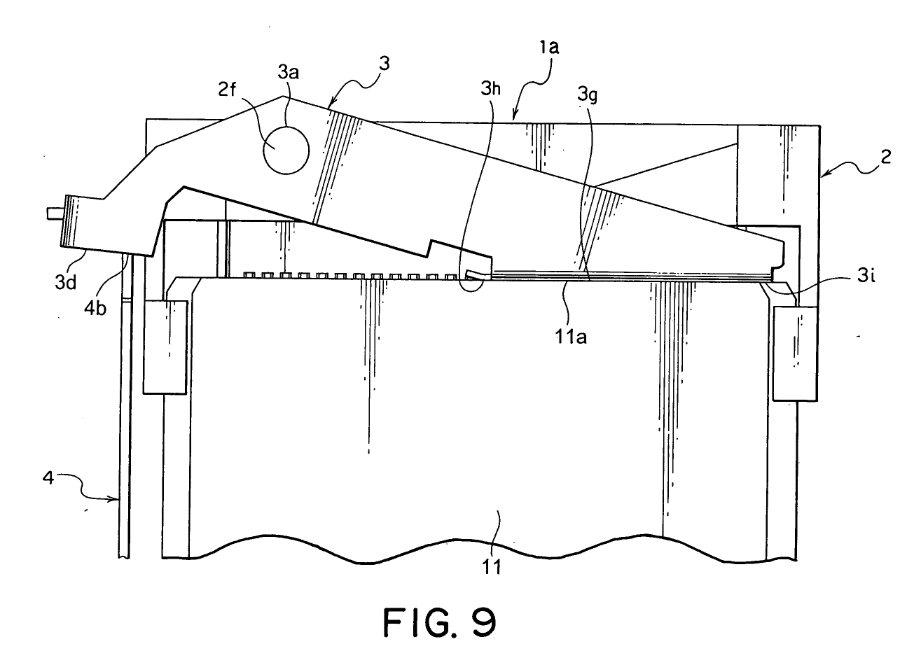

When the slider 4 is pushed, the engaging end 4b of the slider 4 presses the pressed portion 3d of the lever 3. In this event, the lever 3 is rotated around the pivot portion 2f in the clockwise direction. As a result of the rotation of the lever 3, the first card-pressing portion 3h of the lever 3 presses the front edge 11a of the card 11. Consequently, the card 11 is pushed and moved by the first card-pressing portion 3b to be removed from the connector body 2 as illustrated in FIG. 9. Thus, electrical connection between the connector body 2 and the card 11 is disconnected.

The first card-pressing portion 3h is formed on the acting portion 31 at the position where the rotation radius is relatively small. Therefore, only a small operating force is required to remove the card 11 from the connector body 2. In other words, even with a small operating force, a sufficiently large ejecting force is obtained. In the state illustrated in FIG. 9, a whole of the card continuously-pressing portion 3g is contacted with or closely adjacent to one end of the front edge 11a of the card 11.

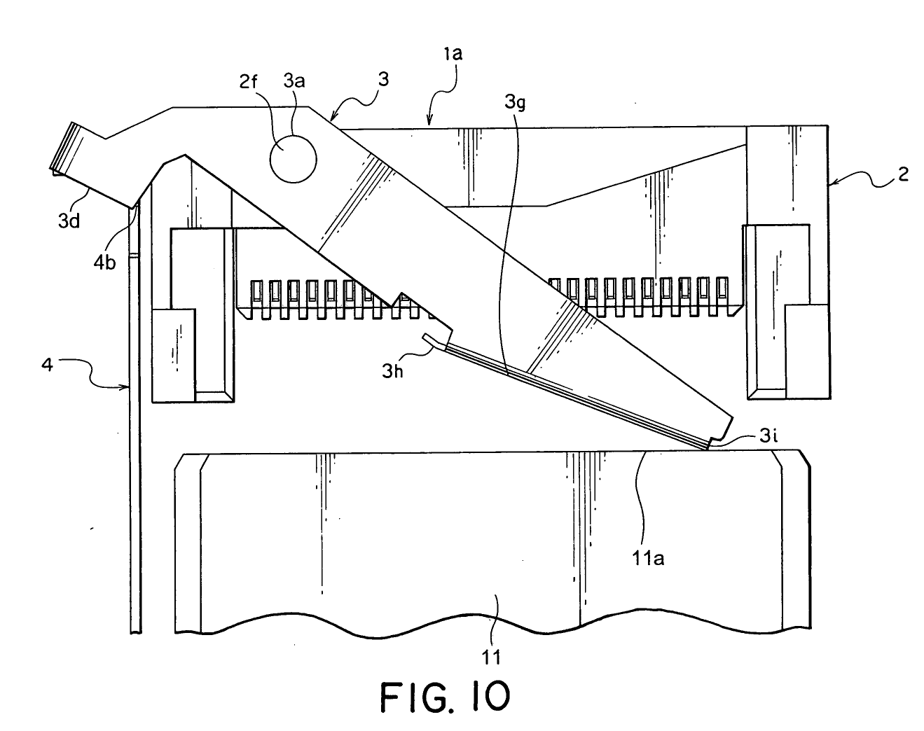

When the slider 4 is further pushed, the lever 3 is further rotated around the pivot portion 2f in the clockwise direction. Then, the second card-pressing portion 3i of the lever 3 presses the front edge 11a of the card 11. As a consequence, the first card-pressing portion 3h of the lever 3 is separated from the card 11. Thereafter, the card 11 is pushed and moved by the second card-pressing portion 3i to be ejected from the card connector 1 as illustrated in FIG. 10.

Since the second card-pressing portion 3i is formed on the acting portion 31 at the position where the rotation radius is relatively large, a sufficiently large stroke can be obtained. It is therefore possible to more reliably eject the card 11 from the card connector 1a.

In the foregoing, the card continuously-pressing portion 3g is linearly formed. Alternatively, the card continuously-pressing portion 3g may be formed into a gentle arc protruding outward.

In the foregoing, the lever 3 is rotated by the slider 4. Alternatively, the lever 3 may be rotated by a finger or another lever.

While this invention has thus far been described in connection with the preferred embodiments thereof, it will readily be possible for those skilled in the art to put this invention into practice in various other manners without departing from the scope set forth in the appended claims.

1. A card connector comprising a connector body to be connected to a card and a lever rotatably attached to said connector body, said lever having a first card-pressing portion formed at a position where a rotation radius is relatively small and a second card-pressing portion formed at a position where the rotation radius is relatively large, said first card-pressing portion being adapted to push and move said card following the rotation of said lever, said second card-pressing portion being adapted to push and move said card after said card is pushed and moved by said first card-pressing portion, thereby removing said card from said connector body.

2. The card connector according to claim 1, wherein said lever has a depressed portion formed between said first and said second card-pressing portions.

3. The card connector according to claim 1, wherein said lever has an additional card-pressing portion formed between said first and said second card-pressing portions to push said card following the rotation of said lever.

4. The card connector according to claim 1, wherein said additional card-pressing portion smoothly connect said first and said second card-pressing portions to each other.

5. The card connector according to claim 1, wherein said connector body has a card guide for guiding the movement of said card.

6. The card connector according to claim 5, wherein said card guide has a pair of guiding members faced to each other with a space left therebetween and adapted to guide the movement of said card.

7. The card connector according to claim 1, further comprising a pivot portion coupled to said connector body and said lever for making said lever be rotatable with respect to said connector body, said lever having an acting portion located at one side of said pivot portion and an operating portion located at the other side of said pivot portion, said first and said second pressing portions being formed on said acting portion.

8. The card connector according to claim 7, wherein said connector body has a frame and a slider slidable along said frame in a predetermined direction, said slider being engaged with said operating portion.

9. The card connector according to claim 8, wherein said frame has a card guide for guiding the movement of said card in said predetermined direction.

10. The card connector according to claim 8, wherein said slider has a first end engaged with said operating portion and a second end having an operating button.
